(19) United States
(12) Patent Application Publication
(10) Pub. No.: US 2024/0137889 A1
(43) Pub. Date: Apr. 25, 2024

(54) ADMISSION CONTROL BASED ON REGISTERED USER EQUIPMENTS

(71) Applicant: Lenovo (Singapore) Pte. Ltd., New Tech Park (SG)

(72) Inventors: Genadi Velev, Darmstadt (DE); Dimitrios Karampatsis, Ruislip (GB)

(21) Appl. No.: 18/546,257

(22) PCT Filed: Feb. 14, 2022
(86) PCT No.: PCT/IB2022/051299

§ 371 Date: Aug. 10, 2023

Related U.S. Application Data
(60) Provisional application No. 63/149,159, filed on Feb. 12, 2021.

(51) Int. Cl. H04W 60/00; H04W 48/18

(52) U.S. Cl. CPC H04W 60/00; H04W 48/18

(57) ABSTRACT

Apparatuses, methods, and systems are disclosed for admission control based on registered user equipments. One method includes receiving, at a first network function (NF), an indication from a second NF to subscribe to notifications for an admission control mode of a network slice. The method includes determining a number of user equipments (UEs) registered with the network slice. The method includes sending a first request to the second NF to activate the admission control mode for the network slice based on the number of UEs registered with the network slice being greater than a threshold value. The method includes sending a second request to the second NF to deactivate the admission control mode for the network slice based on the number of UEs registered with the network slice being less than or equal to the threshold value.

### CROSS-REFERENCE TO RELATED APPLICATIONS

This application claims priority to U.S. Patent Application Ser. No. 63/149,159 entitled “APPARATUSES, METHODS, AND SYSTEMS FOR NETWORK SLICE ADMISSION CONTROL” and filed on Feb. 12, 2021 for Genadi Velev, which is incorporated herein by reference in its entirety.

### FIELD

The subject matter disclosed herein relates generally to wireless communications and more particularly relates to admission control based on registered user equipments.

### BACKGROUND

In certain wireless communications networks, admission control may be used for each new registration procedure or protocol data unit (“PDU”) session establishment procedure. In such networks, a network slice admission control function may be overloaded with signaling transmissions.

### BRIEF SUMMARY

Methods for admission control based on registered user equipments are disclosed. Apparatuses and systems also perform the functions of the methods. One embodiment of a method includes receiving, at a first network function (NF), an indication from a second NF to subscribe to notifications for an admission control mode of a network slice. In some embodiments, the method includes determining a number of user equipments (UEs) registered with the network slice. In certain embodiments, the method includes sending a first request to the second NF to activate the admission control mode for the network slice based on the number of UEs registered with the network slice being greater than a threshold value. In various embodiments, the method includes sending a second request to the second NF to deactivate the admission control mode for the network slice based on the number of UEs registered with the network slice being less than or equal to the threshold value.

One apparatus for admission control based on registered user equipments includes a first network function (NF). In some embodiments, the apparatus includes a receiver that receives an indication from a second NF to subscribe to notifications for an admission control mode of a network slice. In various embodiments, the apparatus includes a processor that determines a number of user equipments (UEs) registered with the network slice. In certain embodiments, the apparatus includes a transmitter that: sends a first request to the second NF to activate the admission control mode for the network slice based on the number of UEs registered with the network slice being greater than a threshold value; and sends a second request to the second NF to deactivate the admission control mode for the network slice based on the number of UEs registered with the network slice being less than or equal to the threshold value.

Another embodiment of a method for admission control based on registered user equipments includes transmitting, from a second network function (NF), an indication to a first NF to subscribe to notifications for an admission control mode of a network slice. In some embodiments, the method includes receiving a first request from the first NF to activate the admission control mode for the network slice based on a number of user equipments (UEs) registered with the network slice being greater than a threshold value. In certain embodiments, the method includes receiving a second request from the first NF to deactivate the admission control mode for the network slice based on the number of UEs registered with the network slice being less than or equal to the threshold value.

Another apparatus for admission control based on registered user equipments includes a second network function (NF). In some embodiments, the apparatus includes a transmitter that transmits an indication to a first NF to subscribe to notifications for an admission control mode of a network slice. In various embodiments, the apparatus includes a receiver that: receives a first request from the first NF to activate the admission control mode for the network slice based on a number of user equipments (UEs) registered with the network slice being greater than a threshold value; and receives a second request from the first NF to deactivate the admission control mode for the network slice based on the number of UEs registered with the network slice being less than or equal to the threshold value.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for admission control based on registered user equipments;

FIG. 2 is a schematic block diagram illustrating one embodiment of an apparatus that may be used for admission control based on registered user equipments;

FIG. 3 is a schematic block diagram illustrating one embodiment of an apparatus that may be used for admission control based on registered user equipments;

FIG. 4 is a schematic block diagram illustrating one embodiment of a system in which there are a maximum number of UEs per network slice control at registration;

FIG. 5 is a schematic block diagram illustrating one embodiment of a system with procedures for NSAC for a network slice parameter;

FIG. 6 is a schematic block diagram illustrating one embodiment of a system having a monitoring procedure for NSAC;

FIG. 7 is a schematic block diagram illustrating one embodiment of a system for activating and/or deactivating an admission check for NSAC based on a subscribe and/or notify service exposed by the NSACF;

FIG. 8 is a schematic block diagram illustrating one embodiment of a system for activating and/or deactivating an admission check for NSAC based on an NSACF originated request;

FIG. 9 is a flow chart diagram illustrating one embodiment of a method for admission control based on registered user equipments; and

FIG. 10 is a flow chart diagram illustrating another embodiment of a method for admission control based on registered user equipments.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

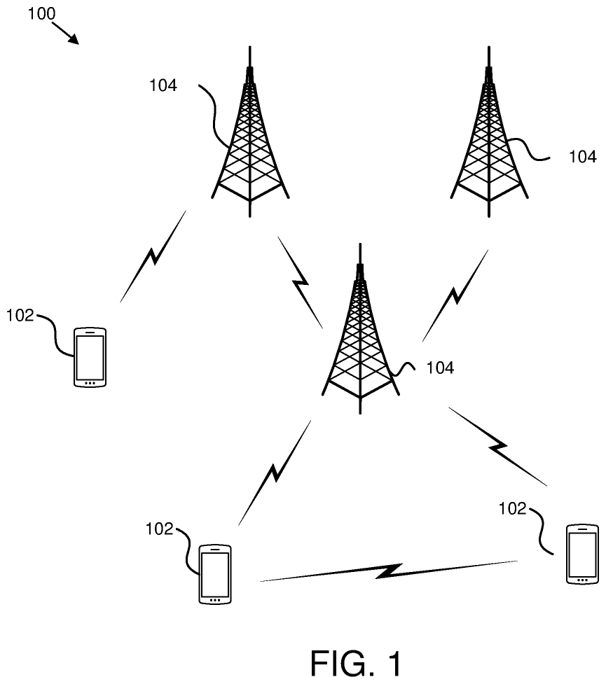

FIG. 1 depicts an embodiment of a wireless communication system 100 for admission control based on registered user equipments. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive, at a first network function (NF), an indication from a second NF to subscribe to notifications for an admission control mode of a network slice. In some embodiments, the network unit 104 may determine a number of user equipments (UEs) registered with the network slice. In certain embodiments, the network unit 104 may send a first request to the second NF to activate the admission control mode for the network slice based on the number of UEs registered with the network slice being greater than a threshold value. In various embodiments, the network unit 104 may send a second request to the second NF to deactivate the admission control mode for the network slice based on the number of UEs registered with the network slice being less than or equal to the threshold value. Accordingly, the network unit 104 may be used for admission control based on registered user equipments.

In certain embodiments, a network unit 104 may transmit, from a second network function (NF), an indication to a first NF to subscribe to notifications for an admission control mode of a network slice. In some embodiments, the network unit 104 may receive a first request from the first NF to activate the admission control mode for the network slice based on a number of user equipments (UEs) registered with the network slice being greater than a threshold value. In certain embodiments, the network unit 104 may receive a second request from the first NF to deactivate the admission control mode for the network slice based on the number of UEs registered with the network slice being less than or equal to the threshold value. Accordingly, the network unit 104 may be used for admission control based on registered user equipments.

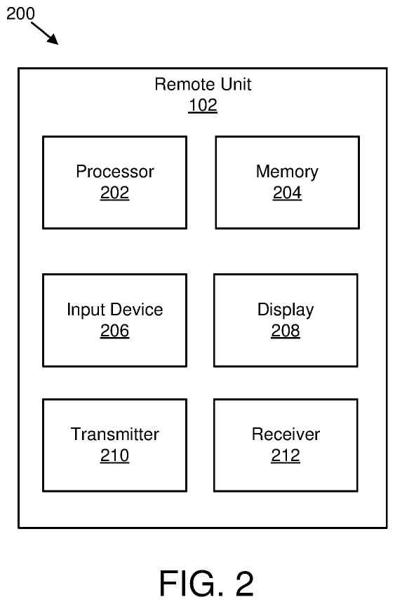

FIG. 2 depicts one embodiment of an apparatus 200 that may be used for admission control based on registered user equipments. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

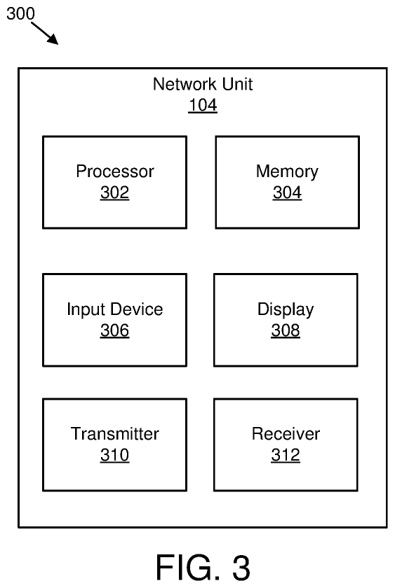

FIG. 3 depicts one embodiment of an apparatus 300 that may be used for admission control based on registered user equipments. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312 receives an indication from a second NF to subscribe to notifications for an admission control mode of a network slice. In various embodiments, the processor 302 determines a number of user equipments (UEs) registered with the network slice. In certain embodiments, the transmitter 310: sends a first request to the second NF to activate the admission control mode for the network slice based on the number of UEs registered with the network slice being greater than a threshold value; and sends a second request to the second NF to deactivate the admission control mode for the network slice based on the number of UEs registered with the network slice being less than or equal to the threshold value.

In some embodiments, the transmitter 310 transmits an indication to a first NF to subscribe to notifications for an admission control mode of a network slice. In various embodiments, the receiver 312: receives a first request from the first NF to activate the admission control mode for the network slice based on a number of user equipments (UEs) registered with the network slice being greater than a threshold value; and receives a second request from the first NF to deactivate the admission control mode for the network slice based on the number of UEs registered with the network slice being less than or equal to the threshold value.

In certain embodiments, a network slice customer (e.g., a vertical or service provider) may negotiate or request network slice characteristics from a network operator deploying a network slice. The network slice characteristics may be identified by network slice attributes. In some embodiments, a generic network slice template (“GST”) may be used by a network operator to derive network slice characteristics.

In various embodiments, to achieve management of network slice attributes in a network, a new network function (“NF”) may be specified with the new NF being responsible for: 1) being aware of one or more network slice attributes to be monitored and/or quotas which need to be enforced; 2) collecting information about the network slice attributes to be monitored; and/or 3) roaming aspects to be considered.

In certain embodiments, if NFs (e.g., AMF and/or SMF) controlling a network slice parameter (e.g., current number of user equipments (“UEs”) or protocol data unit (“PDU”) sessions) request admission control with a network slice admission control functionality (“NSACF”) for each new registration procedure or PDU session establishment procedure, the NSACF may be flooded with signaling. In such embodiments, an optimized mechanism may be used to reduce signaling for admission control.

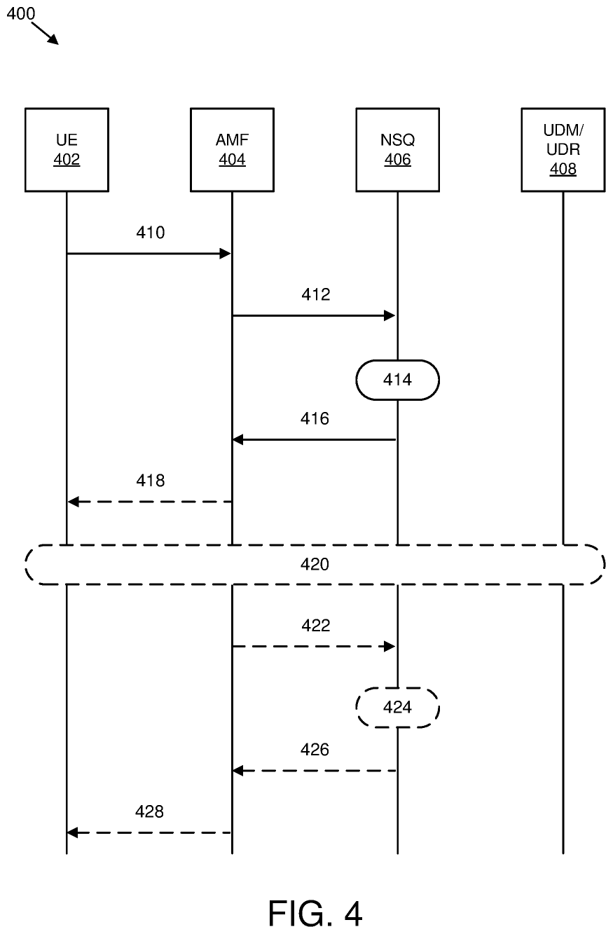

FIG. 4 is a schematic block diagram illustrating one embodiment of a system 400 in which there are a maximum number of UEs per network slice control at registration. The system 400 includes a UE 402, an AMF 404, a network slice quota (“NSQ”) 406, and a UDM/UDR 408. Each of the illustrated communications may include one or more messages.

In some embodiments, such as in FIG. 4, the NSQ 406 network function maintains a list of UE identifiers (“IDs”) that are registered with a network slice. The NSQ 406 may retrieve the quota for a maximum number of UEs (or alternatively with PDU sessions) per network slice from an operations, administration, and management (“OAM”) function.

In a first communication 410, a registration request is sent (e.g., including a UE ID and/or S-NSSAI 1). Moreover, in a second communication 412, during a registration procedure, the AMF 404 sends a request message to the NSQ 406 to check for a number of UEs per network slice quota availability for a first single (“S”) network slice selection assistance information (“NSSAI”) (“S-NSSAI”) (S-NSSAI 1). The AMF 404 includes the UE ID and the S-NSSAI 1 for which the AMF wants to check the quota availability. The NSQ 406 checks 414 whether the quota for the maximum number of UEs per S-NSSAI 1 has already been reached. If the UE ID is already in the list of UEs registered with S-NSSAI 1, then no quota availability check is needed (e.g., quota is available). In a third communication 416, the NSQ 406 returns a response in which the NSQ 406 includes the S-NSSAI 1 for which the quota availability check is done and NSQ status parameter which indicates whether the quota is available or not. In a fourth communication 418, a registration reject message may be sent to the UE 402.

In a fifth communication 420, the registration procedure may continue if rejected. Moreover, in a sixth communication 422, an update request may be sent. Further, the NSQ 406 may check 424 whether the number of UEs per network slice quota is updated. In a seventh communication 426, an update response may be sent. Moreover, in an eighth communication 428, a registration accept message may be sent.

In FIG. 4, there may be a high amount of signaling between the AMF and NSQ since the AMF performs request and response signaling for each UE registration procedure.

In certain embodiments, a network slice (e.g., identified by an S-NSSAI) may be a subject to network slice admission control (“NSAC”). The NSAC is a network feature which allows the use of the S-NSSAI resources up to a maximum number of UEs and/or a maximum number of established PDU sessions in the S-NSSAI or up to a maximum uplink and/or downlink throughput. If the maximum number of UEs and/or a maximum number of established PDU sessions in the S-NSSAI are reached, then new UEs or PDU sessions are rejected.

In some embodiments, for NSAC, a centralized network function called network slice admission control function (“NSACF”) performs monitoring and admission enforcement procedures. In various embodiments, the NSACF performs two procedures (or operations): 1) monitoring the current number of registered UEs or established PDU sessions in the S-NSSAI; and 2) admission control and/or enforcement (or admission check) according to a configured maximum number of UEs and/or established PDU sessions which are allowed to be served by the S-NSSAI subject to NSAC.

In certain embodiments, a NSAC may be applied for a maximum number of UEs or a maximum number of PDU sessions. If an S-NSSAI is subject to NSAC for maximum number of UEs and/or PDU sessions, the NSACF monitors the current number of registered UEs and/or established PDU sessions within the S-NSSAI and compares whether the current number of registered UEs and/or established PDU session exceeds the maximum number of UEs and/or PDU sessions allowed within the S-NSSAI.

In some embodiments, for a monitoring procedure, a NSACF monitors a current number of registered UEs and/or established PDU sessions with the S-NSSAI by subscribing with the AMFs and/or SMFs serving the S-NSSAI to report the current number of registered UEs and/or established PDU sessions within the S-NSSAI in the AMF and/or SMF. The following steps may be performed during the monitoring procedure: 1) the NSACF may subscribe with the AMFs and/or SMFs to report the current number of registered UEs and/or established PDU sessions—in addition, the NSACF configures and updates on demand an event parameter (e.g., EventParameter) and an event reporting parameter (EventReportingParameter) in the AMFs and/or SMFs—by using the EventParameter and EventReportingParameter, the NSACF may control the granularity of sending notifications from AMFs and/or SMFs and the accuracy of the current total number of registered UEs and/or established PDU sessions in the NSACF (e.g., depending on a level of the number of registered UEs and/or established PDU sessions in the NSACF compared to the maximum number of UEs and/or PDU sessions, the NSACF may determine to configure the AMFs and/or SMFs to report periodically and to report a periodicity; or to report immediately on an event base, where the event may be a change and/or offset compared to the previous report sent from the AMF and/or SMF—the finest granularity is reached if the offset is set to 1 because the AMF and/or SMF would report each change of the current number of UEs and/or PDU sessions in the AMF and/or SMF); and/or 2) the AMFs and/or SMFs count internally the current number of registered UEs and/or established PDU sessions (e.g., the number of UEs to which the S-NSSAI is included in the allowed NSSAI). If a UE registers with the S-NSSAI or a UE moves in from another AMF, the AMF increases the number by one. If a UE deregisters with the S-NSSAI or a UE moves away to another AMF, the AMF reduces the number by one.

In various embodiments, for an admission enforcement (or admission check) procedure, an NSACF configures AMFs and/or SMFs with when to start the admission check for each UE registration procedure or PDU session establishment procedure. The NSACF then compares the current number of registered UEs and/or established PDU sessions with the configured maximum number of UEs and/or PDU sessions and, if the maximum number of UEs and/or PDU sessions is reached, the NSACF rejects the UE registration or PDU session establishment procedure. Moreover, the following may be performed: 1) the NSACF offers an event exposure service—the AMFs and/or SMFs may subscribe with the NSACF for notifications of when to start or to stop the admission check request per UE registration or PDU session establishment procedure—the NSACF determines that the admission check should start or stop based on a level of a current number of registered UEs and/or established PDU sessions within the S-NSSAI compared with the maximum number of UEs and/or PDU sessions allowed within the S-NSSAI (e.g., if the current number of registered UEs and/or established PDU sessions reaches 80% of the maximum number of UEs and/or PDU sessions allowed within the S-NSSAI, the NSACF may determine to send notifications to the AMF and/or SMF to start the admission check—if the current number of registered UEs and/or established PDU sessions falls below 75% of the maximum number of UEs and/or PDU sessions allowed within the S-NSSAI, the NSACF may determine to send notifications to the AMF and/or SMF to stop the admission check); and/or 2) the AMF and/or SMF offers a service to allow the NSACF to request the start or stop of the admission check. The NSACF determines the point to activate or deactivate the admission check request per UE registration or PDU session establishment procedure and the NSACF sends a request to the AMF and/or SMF to start or stop the admission check. The NSACF determines that the admission check should start or stop based on a level of a current number of registered UEs and/or established PDU sessions within the S-NSSAI compared with the maximum number of UEs and/or PDU sessions allowed within the S-NSSAI.

In certain embodiments, a network slice is identified by a S-NSSAI. The NSACF may manage one or more of the S-NSSAI parameters (e.g., controlled slice attribute, slice parameter, slice attribute, shown as SliceParameter in the signaling exchanges) per network slice. The parameters may include: 1) a number of terminals (e.g., the number of UEs concurrently registering for a network slice); 2) a number of connections (e.g., the number of PDU sessions concurrently established within a network slice associated with all data network names (“DNNs”); 3) a maximum uplink throughput (e.g., maximum data rate supported by the S-NSSAI in uplink); and/or 4) a maximum downlink throughput (e.g., maximum data rate supported by the S-NSSAI in downlink). For each of the parameters there may be one or more maximum numbers or upper bounds.

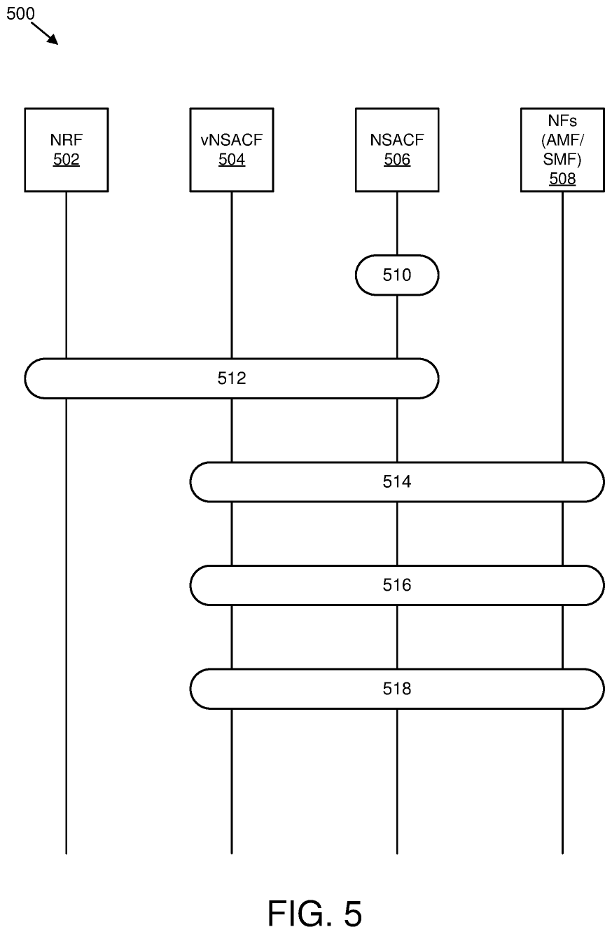

FIG. 5 is a schematic block diagram illustrating one embodiment of a system 500 with procedures for NSAC for a network slice parameter. The system 500 includes a network repository function (“NRF”) 502, at least one distributed NSACF (“vNSACF”) 504, a NSACF 506, and network functions (“NFs”) 508 (e.g., AMFs and/or SMFs). Each of the illustrated communications may include one or more messages.

Specifically, FIG. 5 shows a high-level description of the procedures for NSAC for a network slice parameter. The NSACF 506 may be deployed as a central NSACF instance (e.g., NSACF 506) and as distributed NSACFs instances (e.g., vNSACF 504). The central NSACF is responsible to manage and/or control the global status and/or quota of a controlled slice attribute, whereas global may mean all non-roaming and/or roaming UEs using the network slice resources. The distributed (or visited) NSACFs may be deployed in the same network (e.g., home network such as a home public land mobile network (“PLMN”) (“HPLMN”)) with which the slice customer has a service level agreement (“SLA”)) and/or in roaming partners networks (e.g., visited networks such as visited PLMN (“VPLMN”)). The distributed NSACFs are called vNSACF herein. The distributed NSACFs are responsible to manage local quotas (e.g., collecting data from other NFs and enforcing policies for local quotas). The central NSACF is responsible to manage the local quotas in the distributed NSACFs.

The NSACF 506 is configured 510 by the operations, administration and management (“OAM”) system to control and/or manage particular network slice parameters (e.g., SliceParameter) for a network slice identified by S-NSSAI. The OAM system is aware of the requirement to control a quota of a network slice attribute from the SLA or other contracts between the network operator and the network slice customer. For example, a combination and particular values of the GST parameters may result in a specific network slice type (“NEST”) and further used by the OAM system to create a network slice template (“NST”). The OAM system may determine the configuration of the quantize-map-forward (“QMF”) based on the NST.

In a first communication 512, the NSACF 506 may determine which NFs 508 are responsible for managing the particular controlled slice attribute. In certain embodiments, this information may be directly configured in the NSACF 506 by the OAM in step 510. For example, if the controlled slice attribute is for a number of UEs concurrently registering for a network slice, the NSACF 506 determines that the AMFs serving the corresponding S-NSSAI needs to be discovered. Examples of control plane NFs may be AMF, SMF, PCF, which report to the NSACF 506 and there may be an enforcement policy point if a quota has been consumed. The NSACF 506 may discover these NFs by interrogating with the NRF 502.

In a second communication 514, the NSACF 506 collects information about the current status of the controlled slice attributes of one or more slices. The status of the controlled slice attributes information is collected from the NFs identified in step 512.

In a third communication 516, the NSACF 506 controls the admission enforcing NFs 508 (e.g., AMF, SMF, vNSACF) to start or stop sending admission check for the S-NSSAI. The admission enforcing NFs 508 (e.g., AMF, SMF, vNSACF) may be configured by the OAM so that at least one slice parameter of an S-NSSAI is subject to NSAC. This configuration may require that the admission enforcing NFs 508 and the NSACF 506 need to implement new services to allow the NSACF 506 to control (e.g., activate or deactivate) the admission check performed by the admission enforcing NFs 508 (e.g., AMF, SMF, vNSACF).

In a fourth communication 518, the admission enforcing NFs 508 (e.g., AMF, SMF, vNSACF) send requests for admission check towards the NSACF 506 during one of the following procedures depending on the configuration for NSAC: 1) during UE registration procedure with the S-NSSAI; and/or 2) during a PDU session establishment procedure with the S-NSSAI.

In some embodiments, the method proposed in FIG. 5 may enable NFs to not need to perform a request and/or a response signaling exchange if the current status of the SliceParameter is below a certain level (or threshold). Only if the current status of the SliceParameter is above a certain level, the NSACF will notify and/or request the NFs to start a request and/or a response signaling exchange to check for admission control (e.g., whether to check whether the S-NSSAI resources are available to allow new usage of the S-NSSAI such as new UEs or new PDU sessions).

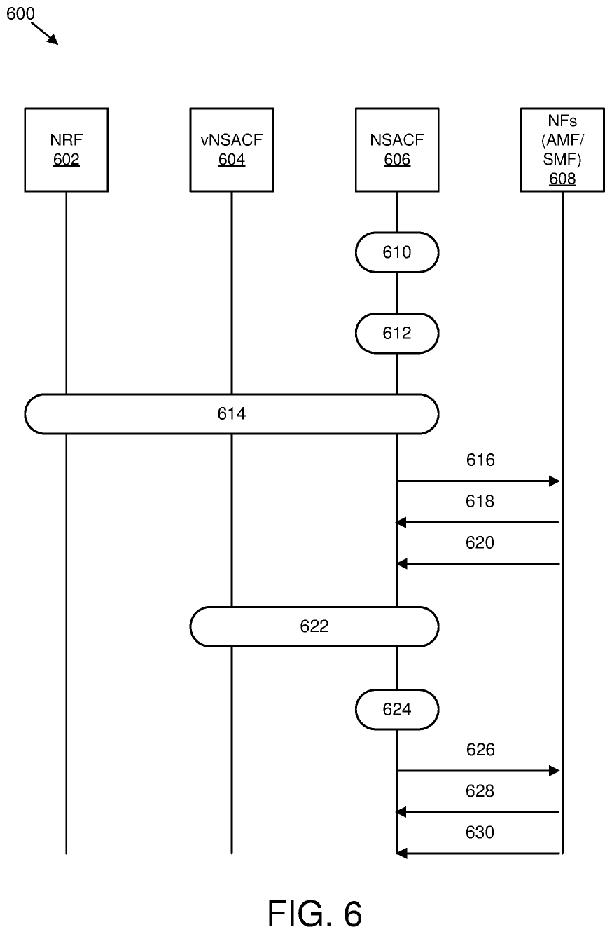

FIG. 6 is a schematic block diagram illustrating one embodiment of a system 600 having a monitoring procedure for NSAC. The system 600 includes a NRF 602, at least one vNSACF 604, a NSACF 606, and NFs 608 (e.g., AMFs and/or SMFs). Each of the illustrated communications may include one or more messages.

Specifically, FIG. 6 shows one embodiment of an NSAC monitoring procedure. In principle, the NSACF configures other NFs (e.g., responsible for the slice parameter handling) to report the current status (e.g., number of UEs or PDU sessions). The NSACF 606 may not always have the exact and/or accurate current status, but if necessary (e.g., if the current status is close to the maximum number of UEs or PDU sessions) the NSACF may maintain the exact current status.

In FIG. 6, a mechanism for a NSAC monitoring procedure is used which minimizes an amount of notification signaling generated from reporting NFs. The NSACF (e.g., on demand) determines and configures via a transmission to the reporting NFs different event reporting parameters depending on the current number of registered UEs and/or established PDU sessions compared to the maximum configured value (e.g., maximum number of UEs or PDU sessions).

The NSACF 606 is configured by an OAM system to control and/or manage particular network slice parameters (e.g., SliceParameter) for a network slice identified by S-NSSAI-1. At least one of the following information may be configured in the NSACF: network slice quota (e.g., maximum number) per SliceParameter per S-NSSAI (e.g., UE maximum number is A for S-NSSAI-1)—for a SliceParameter=PDU Sessions, the maximum number of PDU sessions may be configured to be B for S-NSSAI-1, but the maximum number of PDU sessions may be C for S-NSSAI-2, and so forth. For example, such configuration can be formatted as a triple: Slice ID: <S-NSSAI-1>, SliceParameter: <UEs, PDU Sessions, Throughput UL/DL, etc.>, and Max. Nr: (e.g., maximum number) value.

In certain embodiments, based on the configuration in step 610, the NSACF 606 may determine 612 which reporting NFs 608 are responsible for managing the particular slice attribute to be controlled. For example, if the number of UEs concurrently registering for a network slice should be controlled, the NSACF 606 determines that the AMFs serving the corresponding S-NSSAI need to be discovered. In this case, the QMF discovers all AMFs configured to serve the S-NSSAI-1 by interrogating with the NRF 602. In a similar way, the NSACF 606 may discover other reporting NFs 608 as SMFs or vNSACFs 604.

In a first communication 614, the NSACF 606 may request the NRF 602 to discover the reporting NFs 608 (e.g., AMF, SMF, vNSACF). In addition, the NSACF 606 may subscribe with the NRF 602 to be notified if a new NF, which serves the specific S-NSSAI-1, registers with the NRF 602. If the controlled slice attribute is the number of UEs concurrently registering for the S-NSSAI-1, the NSACF 606 may discover and request the AMFs serving S-NSSAI-1 to collect information. If the controlled slice attribute is the number of PDU sessions concurrently established within the S-NSSAI-1, the NSACF 606 may discover and request the AMFs or SMFs serving S-NSSAI-1 to collect the information. If the controlled slice attribute is the UL or DL data throughput in the S-NSSAI-1, the NSACF 606 may discover and request the SMFs or PCFs serving S-NSSAI-1 to collect the aggregates current data rate.

In a second communication 616 and a third communication 618, the NSACF 606 subscribes with the reporting NFs 608 to collect information about the status of the controlled slice attribute. For this purpose, the NSACF 606 may use services exposed by the AMF, SMF, or vNSACF 604. For example, an existing service Namf_EventExposure (or Nsmf_EventExposure) may be used. A new EventID may also be used (e.g., EventID being the number of SliceParameter (e.g., UEs, PDU sessions, or throughput)) and a new event reporting parameter (e.g., which describes an event filter) may be used. The service offered and/or exposed by the AMF and/or SMF requires the AMF and/or SMF count the number of UEs and/or PDU sessions per S-NSSAI served by the AMF and/or SMF.

For example, the service consumed by the NSACF 606 may be a Namf_EventExposure_Subscribe request (e.g., EventID, sliceID, EventParameter, EventReportingParameter). Certain meanings of the informational elements within the subscribe request may be described as follows: 1) an event ID (e.g., EventID) may identify a number of UEs registered with an S-NSSAI or a number of PDU sessions registered with an S-NSSAI; 2) a slice ID (e.g., sliceID) may identify the S-NSSAI of the network slice subject of quota monitoring (e.g., S-NSSAI-1); 3) an event parameter (e.g., EventParameter) may identify a controlled SliceParameter which should be monitored (e.g., number of UEs, number of PDU sessions, or UL and/or DL data throughput)—in some configurations, the EventParameter may identify an offset value or threshold value related to the EventID (e.g., offset of the UEs, PDU sessions, UL and/or DL throughput currently monitored in the reporting NF and compared to the previous report); and/or 4) an event reporting parameter (e.g., EventReportingParameter) may identify when a notification is sent from the service producer (e.g., from the AMF and/or SMF). The EventReportingParameter may be of a type periodic or event-based. The event-based reporting may indicate immediate reporting if the current status of the EventParameter changes compared to a previous value (e.g., offset value). For example, if the EventReportingParameter or EventParameter includes an offset value 2, this means the if the current number in the reporting NF changes by 2 (e.g., the current number of 2 registered UEs or established PDU sessions increases or decreases by 2), the reporting NF sends a notification to the NSACF 606. For an UL and/or DL throughput attribute, the EventReportingParameter may be expressed as an increase or decrease of a data rate (e.g., by 2 Mbps). If the EventReportingParameter is set to 1, the AMF and/or SMF may send a notification to the NSACF 606 for each change in the number of registered UEs, established PDU sessions, or increased UL and/or DL throughput. The periodic reporting identifies the periodicity of reporting sent to the NSACF 606 (e.g., every 5 minutes).

In various embodiments, if the NSACF 606 requests reporting from the SMF, the NSACF 606 may use an existing Nsmf_EventExposure service offered by the SMF, but specify new events and EventReportingParameters for the AMF case.

In a fourth communication 620, the reporting NFs 608 (e.g., AMF, SMF) locally monitors and/or counts the configured SliceParameter. The AMF and/or SMF may count the UEs, PDU sessions, and/or UL and/or DL throughput. If the EventReportingParameter indicates periodic notifications, the AMF and/or SMF sends periodic notifications. For example, if a reporting NF is an AMF, the notification to the NSACF 606 may be Namf_EventExposure Notify (e.g., Event ID, sliceID, AttributeID, EventParameterStatus=numberOf UEs and/or PDU sessions). The AMF reports according to the configuration in steps 616 and 618 (e.g., either the current number of all UEs registered with the S-NSSAI-1, or the current number of all PDU sessions established with the S-NSSAI-1). If the EventReportingParameter has configured the notifications to be of type immediate event-based reporting and the EventParameter indicates an offset value (e.g., 2), then the AMF may store the last reported EventParameterStatus (e.g., the reported number was 100) and if the current number of SliceParameter changes by the offset value (e.g., the current number is 102), the AMF sends a notification message to the NSACF 606 including the EventParameterStatus=102.

In a fifth communication 622, similar to steps 616, 618, and 620, the NSACF 606 may subscribe with the distributed vNSACFs 604 (e.g., in the same PLMN or in visited PLMNs) to collect information about the status of the controlled SliceParameter. The message sent to the vNSACFs may be similar to steps 616 and 618, but the service producer is different (e.g., vNSACF). For example, the service exposed by the vNSACF 604 may be Nnsacf_EventExposure_Subscribe and the informational elements included in the service may be one of the following: Event ID, sliceID=S-NSSAI-1, EventParameter=[UE, PDU Session, UL and/or DL throughput, offset or threshold of the UE, PDU session, UL and/or DL throughput], EventReportingParameter=[periodic, immediate, etc.]).

In certain embodiments, the vNSACF 604 sends the notifications to the NSACF 606 according to the configuration in a subscribe request service operation. For example, the notifications are sent periodically or event-based according to the EventReportingParameter. The NSACF 606 may update the EventReportingParameter. In some embodiments, the vNSACFs 604 count, collect, and/or monitor information about the status of a slice parameter. If the vNSACFs 604 determine that a configured EventParameter of the slice parameter is reached, the vNSACF 604 sends a notification to the NSACF 606. In various embodiments, the NSACF 606 may subscribe for the reporting and/or notification from other NSACFs, but also the NSACF 606 may send notifications and/or reports to other NSACFs. In other words, the NSACFs may be configured in a hierarchical manner like primary NSACFs and secondary and/or distributed NSACFs.

The NSACF 606 may determine 624 that the EventReportingParameter should be updated based on comparison of the current status and the configured maximum number. For example, if the current number of UEs in the NSACF 606 is below 70% of the configured maximum number of UEs, the NSACF 606 may determine to configure periodic notifications in the AMF and/or SMF. If the current number of UEs in the NSACF 606 increases above a critical value (e.g., 70% of the configured maximum number of UEs), the NSACF 606 determines to update the AMF and/or SMF to send event based notification. In such case, the NSACF 606 may send a new EventReportingParameter to indicate immediate event-based reporting and an offset value (e.g., 3). If the critical value increases above another point (e.g., 80% of the configured maximum number of UEs or PDU sessions), the NSACF 606 may send a new EventReportingParameter to indicate immediate event-based reporting and a lower offset value (e.g., 1). If the NSACF 606 determines that the current status of the slice parameter falls below a threshold (e.g., below 70%), the NSACF 606 updates the event reporting parameter. For example, the NSACF 606 can configure the NFs to again report periodically. In other words, the NSACF 606 may adapt the granularity of reporting by the reporting NFs 608 (or vNSACFs 604) depending on the level of current number of UEs or PDU sessions in the NSACF 606 compared with the configured maximum number of UEs or PDU sessions.

In a sixth communication 626 and a seventh communication 628, the NSACF 606 may send an Namf_EventExposure_Subscribe update (e.g., EventID, sliceID, ParameterID, EventReportingParameter), where a new EventReportingParameter is sent as determined in step 624.

In an eighth communication 630, the reporting NFs 608 (e.g., AMF, SMF, vNSACF) locally monitor and/or count the EventParameter. The AMF and/or SMF may count the UEs, PDU sessions, and/or UL and/or DL throughput. If the EventReportingParameter indicates an immediate event-based notification, the AMF and/or SMF sends the notification immediately when the offset value is reached.

In certain embodiments, if a reporting NF is AMF, the AMF may send Namf_EventExposure Notify (e.g., EventID, sliceID, EventParameterStatus).

In some embodiments corresponding to FIG. 6, an amount of signaling transmitted towards the NSACF 606 is reduced since the NSACF 606 controls (and dynamically updates) the event reporting parameter, and thus, the frequency sending notifications. In various embodiments, the NSACF 606 determines the event reporting parameter based on the current status on the slice parameter in the NSACF 606 compared to the maximum configured value (e.g., maximum number of UEs or PDU sessions).

In certain embodiments, there may be an activating and/or deactivating network slice admission check from an AMF and/or SMF based on an EventExposure service from an NSACF.

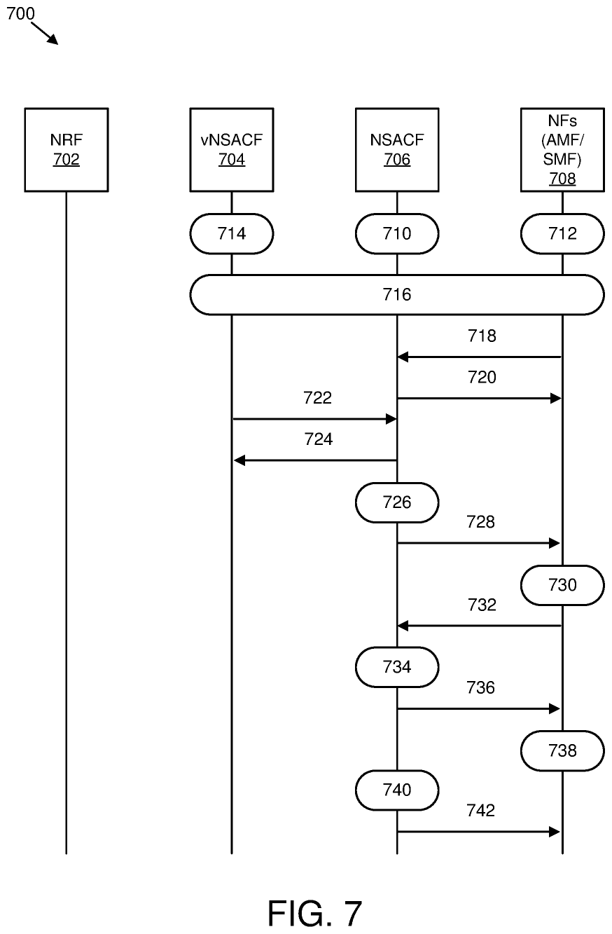

FIG. 7 is a schematic block diagram illustrating one embodiment of a system 700 for activating and/or deactivating an admission check for NSAC based on a subscribe and/or notify service exposed by the NSACF. The system 700 includes a NRF 702, at least one vNSACF 704, a NSACF 706, and NFs 708 (e.g., AMFs and/or SMFs). Each of the illustrated communications may include one or more messages.

Specifically, FIG. 7 describes the details of how the NSACF 706 dynamically adjusts the requests sent for admission enforcement and/or control from the AMF and/or SMF for each new UE registration procedure or PDU session establishment procedure.

In certain embodiments, the NSACF 706 and the other NFs are configured (e.g., by the OAM), or pre-configured locally in the corresponding function with the following information: 1) the NSACF 706 is configured 710 with a max. number of a slice parameter for S-NSSAI which is subject to NSAC—for example, for SliceID=S-NSSAI-1 the SliceParameter subject of NSAC is ‘UE’ and the max. number of UEs allowed to register is ‘A’—for SliceID=S-NSSIA-2, the SliceParameter subject of NSAC is ‘PDU-Session’ and maximum number of PDU sessions allowed to be established is ‘B’; and/or 2) the admission-enforcing NFs 708 (e.g., AMF, SMF, PCF, or vQMF) are configured 712 with information that the S-NSSAI-1 is subject to NSAC, the SliceParameter subject of NSAC (e.g., ‘UE’) and the actions to be performed (e.g., reject new UEs or new PDU sessions) if the NSACF 706 sends a negative response, e.g., rejects, the admission request. The OAM system may configure the NFs 708 with such information. It should be noted that the quota value may not be configured in the NFs 708. In a roaming case as shown in step 714, the vNSACF 704 is configured by the VPLMN's OAM system based SLAs between the HPLMN and VPLMN.

In a first communication 716, the NSACF 706 may execute the monitoring procedure to collect data about the current status of the SliceParameter (e.g., NSACF 706 collects current status data from reporting NFs 708.

In a second communication 718 and a third communication 720, the NSACF 706 offers an event exposure service. The admission-enforcing NFs 708 (e.g., AMF, SMF, or PCF) subscribe with the NSACF 706 to be notified when the NFs 708 should start or stop the signaling (e.g., on a per UE basis) to check for availability whether to admit or reject a new UE or new PDU session. Only admission-enforcing NFs 708 which are configured with one or more controlled SliceParameters may subscribe with the NSACF 706. The admission enforcing signaling may mean that the NFs send a request to the NSACF 706 for admission check (or availability check) whether the NSACF 706 admits or rejects a UE (e.g., during registration procedure) or PDU session (e.g., during PDU session establishment procedure).

In various embodiments, the admission-enforcing NFs 708 may first discover the NSACF 706 responsible for the specific S-NSSAI (e.g., S-NSSAI-1, S-NSSAI-2). Moreover, the admission-enforcing NFs 708 may discover the specific NSACF 706 for the S-NSSAI-1 by using the NRF services, where the NF type is set to be QMF and the slice ID is used as an input parameter.

In certain embodiments, the NFs 708 may send a request to subscribe with the NSACF 706 by using an existing signaling, e.g. event exposure service (e.g., Nnsacf_EventExposure) or a new service (e.g., Nqmf_QuotaLimit) may be used. For an existing service, the request message may be like Nnsacf_EventExposure_Subscribe (e.g., SliceID=S-NSSAI-1, EventID=StartAdmissionCheck, EventID=StopAdmissionCheck). The parameter EventID may identify that the consumer NF (e.g., admission-enforcing NF) is to be notified if the NF should start sending a request to the NSACF 706 to check whether to admit or reject a new UE (e.g., during a registration procedure) or a new PDU session (e.g., during a PDU session establishment procedure).

In some embodiments, an AMF and/or the SMF may first send a request to subscribe to the event StartAdmissionCheck. After the AMF and/or the SMF has been notified that the admission check should start, the AMF and/or the SMF may send a request to subscribe to an event StopAdmissionCheck. In other words, the events StartAdmissionCheck and StopAdmissionCheck are not sent in the same subscription request message but may depend on the current status in the AMF and/or the SMF (e.g., if the AMF and/or the SMF does not perform an admission check, the AMF and/or the SMF sends a request to subscribe to the event StartAdmissionCheck; and if the AMF and/or the SMF start performing an admission check, the AMF and/or the SMF sends a request to subscribe to the event StopAdmissionCheck).

In a fourth communication 722 and a fifth communication 724, with the difference that the distributed NSACFs 704 (e.g., in the same network and/or PLMN or in roaming partners networks and/or VPLMNs which in general are shown as vNSACF 704) initiate the signaling with a transmission to register with the NSACF 706 in the HPLMN. The vNSACFs 704 may be pre-configured with the home NSACF's ID (e.g., internet protocol (“IP”) address or fully qualified domain name (“FQDN”)), or the vNSACF 704 may use NRF services to discover the NSACF 706 in the HPLMN.

The NSACF 706 determines 726 whether the current number of SlicePrameter reaches an internally configured level and/or threshold which requires the admission check for each registration of UE or establishment of PDU session. There may be one or more levels and/or thresholds which correspond to the events subscribed by the admission-enforcing NFs 708. The levels and/or thresholds may be configured by the OAM or locally in the NSACF 706. In certain embodiments: 1) there may be a threshold called ‘start of admission check’, which may be 80% of a maximum number of UEs or PDU sessions; and/or 2) there may be a threshold called ‘stop of admission check’, which may be 75% of a maximum number of UEs or PDU sessions.

In some embodiments, if the NSACF 706 determines that the current number of UEs or PDU sessions reaches the threshold ‘start of admission check’, the NSACF 706 triggers notification to the subscribed AMFs and/or SMFs to notify about the corresponding event of ‘start of admission check’.

In a sixth communication 728, if the NSACF 706 determines that the current number of SlicePrameter reaches the threshold ‘start of admission check’ or ‘admission control’ mode, the NSACF 706 triggers notification to the subscribed AMFs and/or SMFs to notify about the corresponding event of ‘start of admission check’ or ‘admission control’ mode. For example, the NSACF 706 sends a message Nnsacf_EventExposure Notify (Slice=S-NSSAI-1, EventID=StartAdmissionCheck) to the subscribed AMFs and/or SMFs.

The AMF and/or SMF (e.g., NFs 708) internally configures 730 to start the admission check for NSAC or ‘admission control’ mode. In case of NSAC for UE concurrent registrations in S-NSSAI, during the UE non-access stratum (“NAS”) registration procedure the AMF sends a request to the NSACF 706 to check whether the UE can be admitted, e.g., availability check. The AMF sends the request after the S-NSSAI has been determined to be a part of the allowed NSSAI, but before sending the registration accept message to the UE, e.g., before the end of the UE registration procedure.

In case of NSAC for PDU sessions established in S-NSSAI, during the NAS PDU session establishment procedure the SMF (or AMF) sends a request to the NSACF 706 to check whether the new PDU session can be admitted. Specifically, for a UE registration procedure, the AMF may determine to send an indication to the NSACF 706 indicating the type of registration (e.g., whether this is a new UE registration with the S-NSSAI (i.e., the S-NSSAI has not been in the allowed NSSAI in the UE's context), or whether this is a UE registration with the S-NSSAI due to mobility (i.e., the S-NSSAI has been in the allowed NSSAI in the UE's context).

In some embodiments, the AMF may determine to not send a Nnsacf_AdmissionCheck_Request message to the NSACF 706 for UEs which have been already registered with the S-NSSAI (e.g., the S-NSSAI has been in the allowed NSSAI in the UE's context). This may happen if the UE moves from one AMF to another AMF. In other words, the AMF may send a Nnsacf_AdmissionCheck_Request message to the NSACF 706 only for UEs which attempt registration with the S-NSSAI, which has not been in the allowed NSSAI in the UE's context.

In a seventh communication 732, the AMF and/or the SMF (e.g., NFs 708) may send a request to check whether a new UE is allowed to be registered or a new PDU session to be established to the S-NSSAI. The NSACF 706 offers the service “Nnsacf_AdmissionCheck”. For example, the AMF and/or SMF may send a Nnsacf_AdmissionCheck_Request (e.g., Slice=S-NSSAI-1, SliceParameter, ProcedureType), where the SliceParameter identifies the slice parameter UEs and/or PDU sessions for which the admission check is performed. The ProcedureType may be relevant for the AMF during the UE registration procedure and may indicate whether this is a new UE registration with the S-NSSAI (e.g., the S-NSSAI has not been in the allowed NSSAI in the UE's context), or whether this is a UE registration with the S-NSSAI due to mobility (e.g., the S-NSSAI has been in the allowed NSSAI in the UE's context).

The NSACF 706 checks 734 internally whether the current number of SliceParameter is equal to the configured maximum number. If the current number of SliceParameter is equal to the configured maximum number, the NSACF 706 sends a result indicating ‘reject’ to the AMF and/or the SMF. If the current number of SliceParameter is smaller than the configured maximum number, the NSACF 706 sends a result indicating ‘accept’ to the AMF and/or the SMF.

In an eighth communication 736, the NSACF 706 sends a response to the AMF and/or the SMF with a result (e.g., accept and/or reject). For example, the NSACF 706 may send a Nnsacf_AdmissionCheck_Response (e.g., Slice=S-NSSAI-1, SliceParameter, Result), where the result parameter may have the values of accept and/or reject.

The admission enforcing NFs 708 (e.g., AMF, SMF) applies 738 the result from step 736. For example, for UE registration to the S-NSSAI (e.g., NSAC applied for number of UEs), if the result parameter indicates that the availability check is rejected, the AMF includes the S-NSSAI in the list of rejected S-NSSAIs and may include an appropriate cause value that the S-NSSAI is rejected due to NSAC. If the result is to accept the registration, the AMF includes the S-NSSAI in the list of allowed S-NSSAIs. The list of rejected S-NSSAIs or the list of allowed S-NSSAIs is included in the registration accept message, e.g., steps 730-736 are performed before the registration accept message is sent to the UE. As another example, for a PDU session establishment procedure with a transmission to the S-NSSAI, if the result is to reject the PDU session establishment, the SMF and/or the AMF sends a PDU session reject message to the UE and may include an appropriate cause value that the PDU session is rejected due to NSAC. If the result is to accept the PDU session establishment, the SMF and/or the AMF sends a PDU session accept message to the UE.

If the NSACF 706 determines 740 that the current number of SlicePrameter undergoes the threshold ‘stop of admission check’, the NSACF 706 triggers notification to the subscribed AMFs and/or SMFs to notify about the corresponding event of ‘stop of admission check’.

In a ninth communication 742, if the NSACF 706 determines that the current number of SlicePrameter falls below the threshold ‘stop of admission check’, the NSACF 706 sends a notification to the subscribed AMFs and/or SMFs to notify about the corresponding event of ‘stop of admission check’ or deactivate the admission control mode.

In certain embodiments, the NSACF 706 may sends a message Nnsacf_EventExposure Notify (e.g., Slice=S-NSSAI-1, EventID=StopAdmissionCheck) to the subscribed AMFs and/or SMFs.

In some embodiments, the embodiment in FIG. 7 may minimize the signaling sent from the AMF and/or the SMF for the admission check for NSAC. The embodiment in FIG. 7 uses a new service offered by the NSACF 706 to notify the consumers (e.g., admission-enforcing NFs (e.g., AMF, SMF, or vNSACF)) about the requirement to start or stop the admission check, e.g., to activate or deactivated admission control mode. The admission-enforcing NFs (e.g., AMF, SMF, or vNSACF) subscribe to the service offered by the NSACF if they are configured with the S-NSSAI subject to NSAC. By using this solution, the admission-enforcing NFs (e.g., AMF, SMF, or vNSACF) send signaling for an admission check to the NSACF only when configured by the NSACF.

In various embodiments, there may be activating and/or deactivating of a network slice admission check from an AMF and/or an SMF based on a request service from a NSACF. In such embodiments, the NSACF requests corresponding admission-enforcing NFs to start or to stop a network slice admission check. The NSACF determines to send the request to the AMF and/or the SMF (e.g., to start or stop the reporting) based on the current status and/or number of the SliceParameter compared to the configured maximum number for the SliceParameter.

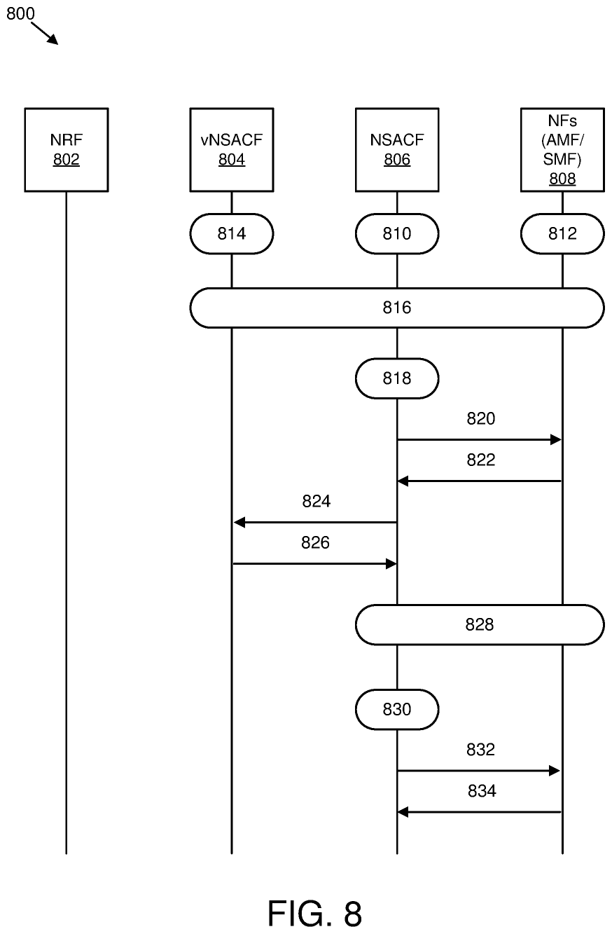

FIG. 8 is a schematic block diagram illustrating one embodiment of a system 800 for activating and/or deactivating an admission check for NSAC based on an NSACF originated request. The system 800 includes a NRF 802, at least one vNSACF 804, a NSACF 806, and NFs 808 (e.g., AMFs and/or SMFs). Each of the illustrated communications may include one or more messages.

Steps 810, 812, and 814 may be substantially similar to steps 710, 712, and 714 of FIG. 7. Moreover, the NSACF 806 is not configured to offer an EventExposure service to the AMFs and/or the SMFs, but instead the NSACF 806 is able to be a consumer of a service offered by the AMFs and/or the SMFs to control (e.g., activate or deactivate) the requests for admission check. The AMFs and/or the SMFs are configured to offer a service to request the control (e.g., activate or deactivate) the requests for admission check.

A first communication 816 may be substantially similar to the first communication 716 of FIG. 7.

The NSACF 806 determines 818 to activate the admission check for NSAC with a transmission towards the admission enforcing NFs 808 (e.g., AMF, SMF, vNSACF). The NSACF 806 determines the activation by considering the current total status of the SlicePrameter (e.g., current number of registered UEs and/or established PDU sessions) and comparing it with the maximum number of the SlicePrameter (e.g., maximum number of UEs and/or PDU sessions). If the current total current number of registered UEs and/or established PDU sessions is above a particular level (e.g., 80% of the maximum number of the SlicePrameter), the NSACF 806 may decide to activate the admission check for NSAC.

In certain embodiments, the NSACF 806 may discover the admission enforcing NFs 808 (e.g., AMF, SMF, vNSACF) in advance by using NRF services and the S-NSSAI subject to NSAC. The admission enforcing NFs 808 (e.g., AMF, SMF, vNSACF) may be the same NFs which are also involved a monitoring procedure described herein.

In a second communication 820 and a third communication 822, the NSACF 806 sends a request to the AMF and/or the SMF to activate (or start) the admission check for NSAC. The NSACF 806 may send a Namf_AdmissionCheck_Request (e.g., SliceID, SliceParameter, Policy=StartAdmissionCheck) message, where the SliceID identifies the S-NSSAI subject to NSAC, the SliceParameter identifies the slice parameter and/or attribute (e.g., number of UEs or PDU sessions) to be admitted and the Policy=StartAdmissionCheck identifies the action requested towards the AMF and/or the SMF.

A fourth communication 824 and/or a fifth communication 826 may be substantially similar to steps 722 and 724 of FIG. 7, but performed towards the vNSACFs 804 instead of from them.

In a sixth communication 828, the AMF and/or the SMF (e.g., NFs 812) may perform an admission check (e.g., similar to steps 730 through 738 from FIG. 7).

The NSACF 806 determines 830 to deactivate the admission check for NSAC towards the admission enforcing NFs 808 (e.g., AMF, SMF, vNSACF). The NSACF 806 determines the deactivation by considering the current total number of registered UEs and/or established PDU sessions and compares it with the maximum number of UEs and/or PDU sessions. If the current total current number of registered UEs and/or established PDU sessions falls below a particular level (e.g., 75% of the maximum number of UEs and/or PDU sessions), the NSACF 806 may decide to activate the admission check for NSAC.

In the seventh communication 832 and the eighth communication 834, the NSACF 806 sends a request to the AMF and/or the SMF to stop the admission check for NSAC.

In various embodiments, the embodiment of FIG. 8 may minimize the signaling sent from the AMF and/or the SMF for the admission check for NSAC. In such embodiments, FIG. 8 may use a new service offered by the admission-enforcing NFs 808 (e.g., AMF, SMF, or vNSACF) to allow configuration by the NSACF 806 to activate or deactivate the admission check operation in the admission-enforcing NFs 808 (e.g., AMF, SMF, or vNSACF). The NSACF 806 sends requests to the AMFs and/or the SMFs to start or stop the admission check. By using this solution, the admission-enforcing NFs 808 (e.g., AMF, SMF, or vNSACF) send signaling for admission check to the NSACF 806 only if configured by the NSACF 806.

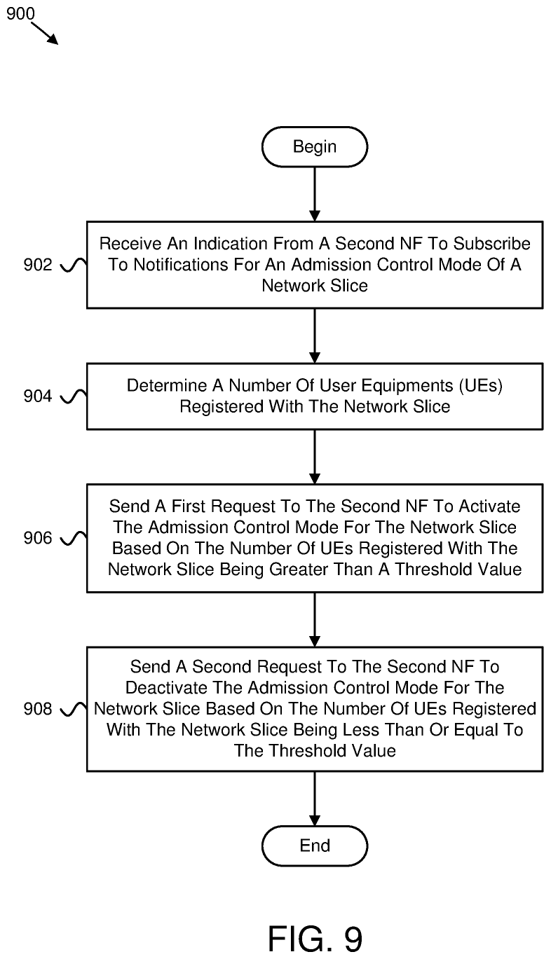

FIG. 9 is a flow chart diagram illustrating one embodiment of a method 900 for admission control based on registered user equipments. In some embodiments, the method 900 is performed by an apparatus, such as the network unit 104. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes receiving 902, at a first network function (NF), an indication from a second NF to subscribe to notifications for an admission control mode of a network slice. In some embodiments, the method 900 includes determining 904 a number of user equipments (UEs) registered with the network slice. In certain embodiments, the method 900 includes sending 906 a first request to the second NF to activate the admission control mode for the network slice based on the number of UEs registered with the network slice being greater than a threshold value. In various embodiments, the method 900 includes sending 908 a second request to the second NF to deactivate the admission control mode for the network slice based on the number of UEs registered with the network slice being less than or equal to the threshold value.

In certain embodiments, the admission control mode triggers a procedure for UEs availability check for the network slice before sending a registration accept message to the UE. In some embodiments, the admission control mode applies only if a procedure for UEs availability check for the network slice is to increase the number of UEs. In various embodiments, determining the number of UEs registered with the network slice comprises receiving notifications from the second NF about a current status of the number of UEs registered with the network slice.

In one embodiment, the method 900 further comprises receiving a request from the second NF to change the number of UEs. In certain embodiments, the first NF comprises a network slice admission control function (NSACF). In some embodiments, the second NF comprises an access and mobility management function (AMF), a distributed NSACF, a session management function (SMF), or some combination thereof.

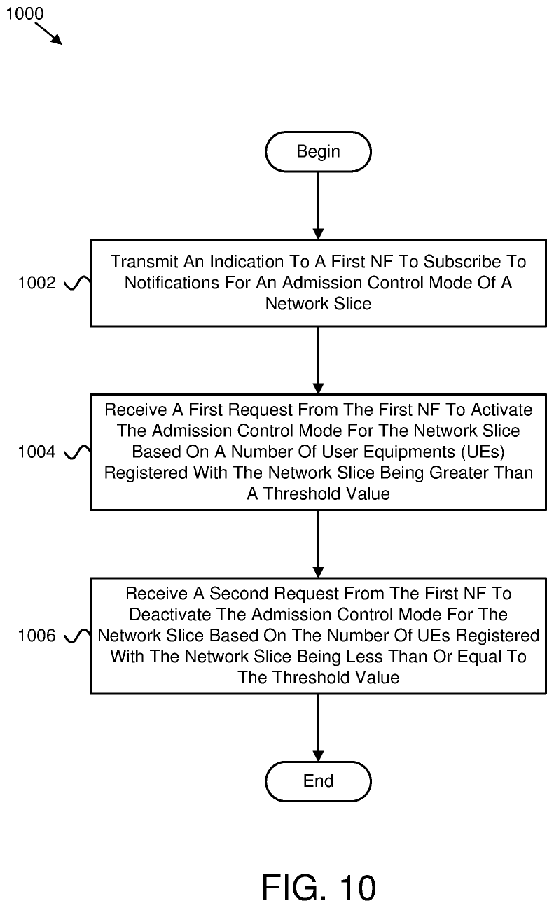

FIG. 10 is a flow chart diagram illustrating another embodiment of a method 1000 for admission control based on registered user equipments. In some embodiments, the method 1000 is performed by an apparatus, such as the network unit 104. In certain embodiments, the method 1000 may be performed by a processor executing program code, for example, a microcontroller, a microprocessor, a CPU, a GPU, an auxiliary processing unit, a FPGA, or the like.

In various embodiments, the method 1000 includes transmitting 1002, from a second network function (NF), an indication to a first NF to subscribe to notifications for an admission control mode of a network slice. In some embodiments, the method 1000 includes receiving 1004 a first request from the first NF to activate the admission control mode for the network slice based on a number of user equipments (UEs) registered with the network slice being greater than a threshold value. In certain embodiments, the method 1000 includes receiving 1006 a second request from the first NF to deactivate the admission control mode for the network slice based on the number of UEs registered with the network slice being less than or equal to the threshold value.

In certain embodiments, the admission control mode triggers a procedure for UEs availability check for the network slice before sending a registration accept message to the UE. In some embodiments, the admission control mode applies only if a procedure for UEs availability check for the network slice is to increase the number of UEs. In various embodiments, the method 1000 further comprises transmitting notifications about a current status of the number of UEs registered with the network slice.

In one embodiment, the method 1000 further comprises transmitting a request to the first NF to change the number of UEs. In certain embodiments, the first NF comprises a network slice admission control function (NSACF). In some embodiments, the second NF comprises an access and mobility management function (AMF), a distributed NSACF, a session management function (SMF), or some combination thereof.

In one embodiment, an apparatus comprises a first network function (NF). The apparatus further comprises: a receiver that receives an indication from a second NF to subscribe to notifications for an admission control mode of a network slice; a processor that determines a number of user equipments (UEs) registered with the network slice; and a transmitter that: sends a first request to the second NF to activate the admission control mode for the network slice based on the number of UEs registered with the network slice being greater than a threshold value; and sends a second request to the second NF to deactivate the admission control mode for the network slice based on the number of UEs registered with the network slice being less than or equal to the threshold value.

In certain embodiments, the admission control mode triggers a procedure for UEs availability check for the network slice before sending a registration accept message to the UE.

In some embodiments, the admission control mode applies only if a procedure for UEs availability check for the network slice is to increase the number of UEs.

In various embodiments, the processor determining the number of UEs registered with the network slice comprises the receiver receiving notifications from the second NF about a current status of the number of UEs registered with the network slice.

In one embodiment, the receiver receives a request from the second NF to change the number of UEs.

In certain embodiments, the first NF comprises a network slice admission control function (NSACF).

In some embodiments, the second NF comprises an access and mobility management function (AMF), a distributed NSACF, a session management function (SMF), or some combination thereof.

In one embodiment, a method of a first network function (NF) comprises: receiving an indication from a second NF to subscribe to notifications for an admission control mode of a network slice; determining a number of user equipments (UEs) registered with the network slice; sending a first request to the second NF to activate the admission control mode for the network slice based on the number of UEs registered with the network slice being greater than a threshold value; and sending a second request to the second NF to deactivate the admission control mode for the network slice based on the number of UEs registered with the network slice being less than or equal to the threshold value.

In certain embodiments, the admission control mode triggers a procedure for UEs availability check for the network slice before sending a registration accept message to the UE.

In some embodiments, the admission control mode applies only if a procedure for UEs availability check for the network slice is to increase the number of UEs.

In various embodiments, determining the number of UEs registered with the network slice comprises receiving notifications from the second NF about a current status of the number of UEs registered with the network slice.

In one embodiment, the method further comprises receiving a request from the second NF to change the number of UEs.

In certain embodiments, the first NF comprises a network slice admission control function (NSACF).

In some embodiments, the second NF comprises an access and mobility management function (AMF), a distributed NSACF, a session management function (SMF), or some combination thereof.

In one embodiment, an apparatus comprises a second network function (NF). The apparatus further comprises: a transmitter that transmits an indication to a first NF to subscribe to notifications for an admission control mode of a network slice; and a receiver that: receives a first request from the first NF to activate the admission control mode for the network slice based on a number of user equipments (UEs) registered with the network slice being greater than a threshold value; and receives a second request from the first NF to deactivate the admission control mode for the network slice based on the number of UEs registered with the network slice being less than or equal to the threshold value.

In certain embodiments, the admission control mode triggers a procedure for UEs availability check for the network slice before sending a registration accept message to the UE.

In some embodiments, the admission control mode applies only if a procedure for UEs availability check for the network slice is to increase the number of UEs.

In various embodiments, the transmitter transmits notifications about a current status of the number of UEs registered with the network slice.

In one embodiment, the transmitter transmits a request to the first NF to change the number of UEs.

In certain embodiments, the first NF comprises a network slice admission control function (NSACF).

In some embodiments, the second NF comprises an access and mobility management function (AMF), a distributed NSACF, a session management function (SMF), or some combination thereof.

In one embodiment, a method of a second network function (NF) comprises: transmitting an indication to a first NF to subscribe to notifications for an admission control mode of a network slice; receiving a first request from the first NF to activate the admission control mode for the network slice based on a number of user equipments (UEs) registered with the network slice being greater than a threshold value; and receiving a second request from the first NF to deactivate the admission control mode for the network slice based on the number of UEs registered with the network slice being less than or equal to the threshold value.

In certain embodiments, the admission control mode triggers a procedure for UEs availability check for the network slice before sending a registration accept message to the UE.

In some embodiments, the admission control mode applies only if a procedure for UEs availability check for the network slice is to increase the number of UEs.

In various embodiments, the method further comprises transmitting notifications about a current status of the number of UEs registered with the network slice.

In one embodiment, the method further comprises transmitting a request to the first NF to change the number of UEs.

In certain embodiments, the first NF comprises a network slice admission control function (NSACF).

In some embodiments, the second NF comprises an access and mobility management function (AMF), a distributed NSACF, a session management function (SMF), or some combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a first network function (NF), the apparatus comprising:
at least one memory; and
at least one processor coupled with the at least one memory and configured to cause the apparatus to:
determine a number of user equipments (UEs) registered with a network slice; and
transmit an indication to a second NF to activate an admission control mode for the network slice based on the number of UEs registered with the network slice being greater than a threshold value, or deactivate the admission control mode for the network slice based on the number of UEs registered with the network slice being less than or equal to the threshold value.

2. The apparatus of claim 1, wherein the admission control mode triggers a procedure for UEs availability check for the network slice before sending a registration accept message to the UE.

3. The apparatus of claim 1, wherein the admission control mode applies only if a procedure for UEs availability check for the network slice is to increase the number of UEs.

4. The apparatus of claim 1, wherein the at least one processor is configured to cause the first NF to determine the number of UEs registered with the network slice comprises the at least one processor configured to cause the first NF to receive one or more notifications from the second NF indicating a current status of the number of UEs registered with the network slice.

5. The apparatus of claim 4, wherein the at least one processor is configured to cause the first NF to receive a request from the second NF to change the number of UEs registered with the network slice.

6. The apparatus of claim 1, wherein the first NF comprises a network slice admission control function (NSACF), wherein the second NF comprises an access and mobility management function (AMF), a distributed NSACF, a session management function (SMF), or a combination thereof.

7. (canceled)

8. A method of performing a first network function (NF), the method comprising:
determining a number of user equipments (UEs) registered with a network slice; and
transmitting a request to a second NF to activate an admission control mode for the network slice based on the number of UEs registered with the network slice being greater than a threshold value, or deactivate the admission control mode for the network slice based on the number of UEs registered with the network slice being less than or equal to the threshold value.

9. An apparatus for performing a second network function (NF), the apparatus comprising:
at least one memory; and
at least one processor coupled with the at least one memory and configured to cause the apparatus to:
receive a request from a first NF to activate an admission control mode for a network slice based on a number of user equipments (UEs) registered with the network slice being greater than a threshold value, or deactivate the admission control mode for the network slice based on the number of UEs registered with the network slice being less than or equal to the threshold value.

10. The apparatus of claim 9, wherein the admission control mode triggers a procedure for UEs availability check for the network slice before transmitting a registration accept message to at least one UE of the number of UEs registered to the network slice.

11. The apparatus of claim 9, wherein the admission control mode is applicable if a procedure for UEs availability check for the network slice corresponds to an increase of the number of UEs.

12. The apparatus of claim 9, wherein the at least one processor is configured to cause the second NF to transmit one or more notifications indicating a current status of the number of UEs registered with the network slice.

13. The apparatus of claim 9, wherein the at least one processor is configured to cause the second NF to transmit a request to the first NF to change the number of UEs registered with the network slice.

14. The apparatus of claim 9, wherein the first NF comprises a network slice admission control function (NSACF), wherein the second NF comprises an access and mobility management function (AMF), a distributed NSACF, a session management function (SMF), or a combination thereof.

15. (canceled)

16. A method of performing a second network function (NF), the method comprising:
receiving a request from a first NF to activate an admission control mode for a network slice based on a number of user equipments (UEs) registered with the network slice being greater than a threshold value, or deactivate the admission control mode for the network slice based on the number of UEs registered with the network slice being less than or equal to the threshold value.

17. The method of claim 16, wherein the admission control mode triggers a procedure for UEs availability check for the network slice before transmitting a registration accept message to at least one UE of the number of UEs registered to the network slice.

18. The method of claim 16, wherein the admission control mode is applicable if a procedure for UEs availability check for the network slice corresponds to an increase of the number of UEs.

19. The method of claim 16, further comprising transmitting one or more notifications indicating a current status of the number of UEs registered with the network slice.

20. The method of claim 16, further comprising transmitting a request to the first NF to change the number of UEs registered with the network slice.

21. The apparatus of claim 1, wherein the at least one processor is configured to cause the first NF to:
receive an indication from the second NF to subscribe for notification associated with the admission control mode of the network slice.

22. The apparatus of claim 9, wherein the at least one processor is configured to cause the second NF to:
transmit an indication to the first NF to subscribe for notification associated with the admission control mode of the network slice.
